(19) United States
(12) Patent Application Publication
(10) Pub. No.: US 2015/0039873 A1
(43) Pub. Date: Feb. 5, 2015

(54) PROCESSOR PROVIDING MULTIPLE SYSTEM IMAGES

(71) Applicants: Gregg B. Lesartre, Fort Collins, CO (US); Vincent Nguyen, Houston, TX (US); Patrick Knebel, Fort Collins, CO (US)

(72) Inventors: Gregg B. Lesartre, Fort Collins, CO (US); Vincent Nguyen, Houston, TX (US); Patrick Knebel, Fort Collins, CO (US)

(21) Appl. No.: 14/387,887

(22) PCT Filed: Apr. 30, 2012
(86) PCT No.: PCT/US2012/035782

§ 371 Date: Sep. 25, 2014

(51) Int. Cl. G06F 9/44; G06F 9/445

(52) U.S. Cl. CPC G06F 9/4403; G06F 9/44505
USPC 713/1

(57) ABSTRACT

An example processor includes a plurality of processing core components, one or more memory interface components, and a management component, wherein the one or more memory interface components are each shared by the plurality of processing core components, and wherein the management component is configured to assign each of the plurality of processing core components to one of a plurality of system images.

### BACKGROUND

Multi-core processors were introduced to advance the processor technology space when single core processors, for the most part, reached their physical limitations with respect to complexity and speed. Unlike a single-core processor, which generally includes a single processor core in a single integrated circuit (IC), a multi-core processor generally includes two or more processor cores in a single IC. For example, a dual-core processor comprises two processor cores in a single IC, and a quad-core processor comprises four processor cores in a single IC.

Regardless of the number of processor cores in the IC, the benefit of the multi-core architecture is typically the same: enhanced performance and/or efficient simultaneous processing of multiple tasks (i.e., parallel processing). Consumer and enterprise devices such as desktops, laptops, and servers take advantage of these benefits to improve response-time when running processor-intensive processes, such as antivirus scans, ripping/burning media, file searching, servicing multiple external requests, and the like.

### BRIEF DESCRIPTION OF THE DRAWINGS

Example embodiments are described in the following detailed description and in reference to the drawings, in which:

FIG. 1 depicts a processor in accordance with an embodiment;

FIG. 2 depicts a system in accordance with an embodiment;

FIG. 3 depicts a processor in accordance with another embodiment;

FIG. 4 depicts a processor in accordance with still another embodiment;

FIG. 5 depicts a process flow diagram in accordance with an embodiment; and

FIG. 6 depicts a process flow diagram in accordance with another embodiment.

### DETAILED DESCRIPTION

Various embodiments of the present disclosure are directed to a multi-core processor architecture. More specifically, various embodiments are directed to a multi-core processor architecture wherein each processor core is allocated to one of a plurality of system images, and processor components such as memory interfaces and input/output components are shared by the plurality of system images. As described in greater detail below, this novel and previously unforeseen approach provides for more efficient and affective utilization of a single processor socket.

By way of background, there has bean recognition that processor densities achievable with current technologies are beyond what a single system image requires for many applications. For these applications, more cores, and in soma cases special processing units, do not add value proportional to their incremental costs. Rather, the processing power associated with each core in multi-core processors is often underutilized if utilized at all. While solutions such as “visualization” and “physicalization” have been introduced to address these inefficiencies, such solutions have their own respective drawbacks. Moreover, they do not squarely address the issue of how to efficiently and effectively utilize each processor core in a multi-core processor. For example, visualization software (e.g., VMWare) is generally designed to share multiple high-performance processors in a server among multiple system images running under a hypervisor. This software is beneficial because it makes information technology (IT) infrastructure more flexible and simpler to manage. Moreover, it reduces hardware and energy costs by consolidating to a smaller number of highly-utilized servers. However, the virtualization software is often associated with high licensing fees, and the associated hypervisor may be considered a large fault zone or single point of failure. In addition, the visualization software imposes a performance overhead on the host system. Therefore, while there are various benefits associated with visualization solutions, there are also various disadvantages associated with the solution.

Physicalization, by contrast, is positioned at the other end of the spectrum from virtualization. Physicalization utilizes multiple light-weight servers comprising lower-performance processors in a dense architecture. The general goal is to achieve maximum value, performance, and/or performance per wait by picking the right size processor for each “micrsoserver” node. The benefit of this approach is that it reduces operating costs by eliminating the need for costly virtualization software, and further by focusing on system packaging efficiency. The drawback, however, is that duplicate components are utilized in each micrsoserver node. For example, input/output components, memory, and/or memory interfaces are redundantly included in each micrsoserver node. Moreover, the “one server, one application” physicalization model is often inflexible and difficult to manage.

Various embodiments of the present application address at least the foregoing by utilizing hardware and/or firmware mechanisms that allow multiple system images to share a single processor socket. Stated differently, various embodiments configure a processor socket to run multiple smaller system images rather than one big system image. While each smaller system images may believe it owns an entire processor socket, in actuality, each system image may be running on a portion of the processor socket and sharing processor components with other system images.

This inventive architecture is realized by allocating processor cores to different system images, and by sharing high cost and often underutilized components such as input/output and memory by the different system images. As a result, the cost per system image may be reduced, processor cores and associated components may be efficiently utilized, and risk may be mitigated. For example, when compared to visualization solutions, hypervisor licensing fees and the large fault domain may be eliminated. When compared to physicalization, inflexible provisions and redundant components may be eliminated. Hence, the architecture addresses drawbacks associated with visualization and physicalization, while at the same time advancing processor efficiency to a level previously unforeseen. This inventive architecture is described further below with reference to various example embodiments and various figures.

In one example embodiment of the present disclosure, a processor is provided. The processor comprises a plurality of processing core components, one or more memory interface components, and one or more input/output components. Each of the plurality of processing core components is assigned to one of a plurality of independent and isolated system images. Each of the one or more memory interface components is shared by the plurality of independent and isolated system images. And the one or more input/output components are allocated to the plurality of independent and isolated system images.

In another example embodiment of the present disclosure, a system is provided. The system comprises a processor and one or more memory components. The processor comprises a plurality of processing core components, one or more memory interface components, and one or more input/output components. Each of the plurality of processing core components is assigned to one of a plurality of independent and isolated system images. Each of the one or more memory interface components is shared by the plurality of independent and isolated system images. The one or more input/output components are allocated to the plurality of independent and isolated system images. Each of the one or more memory components is communicatively coupled to one of the one or more memory interface components. And a portion of memory capacity of the one or more memory components is assigned to each of the plurality of independent and isolated system images.

In yet another example embodiment of the present disclosure, another processor is provided. The processor comprises a plurality of processing core components, one or more memory interface components each shared by the plurality of processing core components, and a management component configured to assign each of the plurality of processing core components to one of a plurality of system images.

As used herein, a “system image” is intended to refer to a single computing node running a single operating system (OS) or hypervisor instance, and comprising at least one processor core, allocated memory, and allocated input/output component.

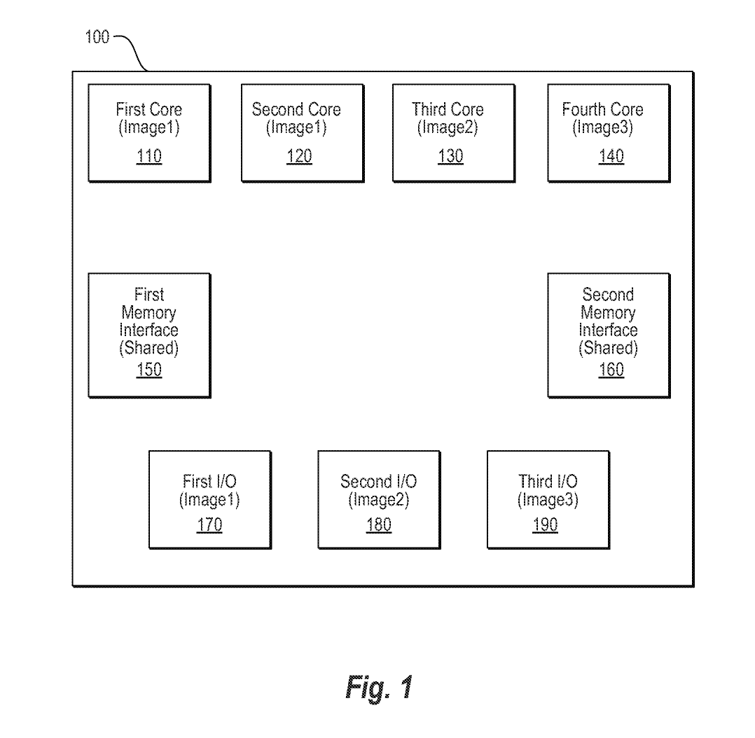

FIG. 1 depicts a processor 100 in accordance with an embodiment. The processor 100 comprises a plurality of processor cores (110-140), a plurality of memory interface components (150-160), and a plurality of input/output components (170-190), each described in greater detail below. It should be readily apparent that the processor 100 depicted in FIG. 1 represents a generalized illustration and that other components may be added or existing components may be removed, modified or rearranged without departing from the scope of the processor 100.

Each processor core (110-140) is a processing device configured to read and execute program instructions. Each core (110-140) may comprise, for example, a control unit (CU) and an arithmetic logic unit (ALU). The CU may be configured to locate, analyze, and/or execute program instructions. The ALU may be configured to conduct calculation, comparing, arithmetic, and/or logical operations. As a whole, each core may conduct operations such as fetch, decode, execute, and/or writeback. While only four processor cores are shown in FIG. 1, it should be understood that more or less processor cores may be included in the processor 100 in accordance with various embodiments. Furthermore, it should be understood that the processor cores (110-140) do not have to be identical, and can vary in terms of processing power, size, speed, and/or other parameters. For example, two processor cores may comprise more processing power than two other processor cores on the same processor 100.

Each memory interface component (150-160) is configured to interface with one or more memory components (not shown), and to manage the flow of data going to and from the one or more memory components. For instance, each memory interface component may contain logic configured to read from the one or more memory components, and to write to the one or more memory components.

Each input/output component (170-190) is configured to provide for the data flow to and from the processor's other internal components (e.g., the processor cores) and components outside of the processor on the board (e.g., a video card). Example input/output components may be, for example, configured in accordance with peripheral component interconnect (PCI), PCI-extended (PCI-X), and/or PCI-express (FCIe). Such input/output component may serve as a motherboard-level interconnects, connecting the processor 100 with both integrated-peripherals (e.g., processor mounted integrated circuits) and add-on peripherals (e.g., expansion cards). Similar to described above with respect to the processor cores, it should be understood that the input/output components (170-190) on the processor 100 do not have to he identical, and each can vary in terms of capabilities, for example.

In various embodiments, the plurality of processor core components (110-140), the plurality of memory interface components (150-160), and the plurality of input/output components (170-190) may be integrated onto a single integrated circuit die. Alternatively, in various embodiments, the plurality of processor core components (110-140), the plurality of memory interface components (150-160), and the plurality of input/output components (170-190) may be integrated onto multiple integrated circuit dies in a single chip package. Regardless of the implementation, the plurality of processor core components (110-140), the plurality of memory interface components (150-160), and the plurality of input/output components (170-190) may be communicatively coupled via one or mere communication busses.

Turning now to the processor 100 operation, various embodiments of the present disclosure deploy multiple system images on the single processor 100. The system images may be independent insofar as one system image may not be influenced, controlled, and/or dependant upon another system image. The system images may be isolated insofar as each system image may be separated from one another such that information with respect to one system image may not be accessible by another system image, for example, a system image with a first company's data may not be influenced or accessible by a system image with a second company's data, even though both run on a single processor.

Each of the plurality of processor cores (110-140) may be allocated to a different independent and isolated system image. Alternatively or in addition, a group processor cores (110-140) may be allocated to an independent and isolated system image. For example, as shown in FIG. 1, the first processor core 110 and the second processor core 120 may be allocated to system image #1, the third processor core 130 may be allocated to system image #2, and the fourth processor core may be allocated to system image #3.

Other processor components may be similarly allocated or shared by one or more of the system images. For example, as shown in FIG. 1, the first input/output component 170 may be allocated to system image #1, the second input/output component 180 may be allocated to system image #2, and the third input/output component 190 may be allocated to system image #3. Further, the first memory interface 150 and the second memory interface 160 may be shared by each system image.

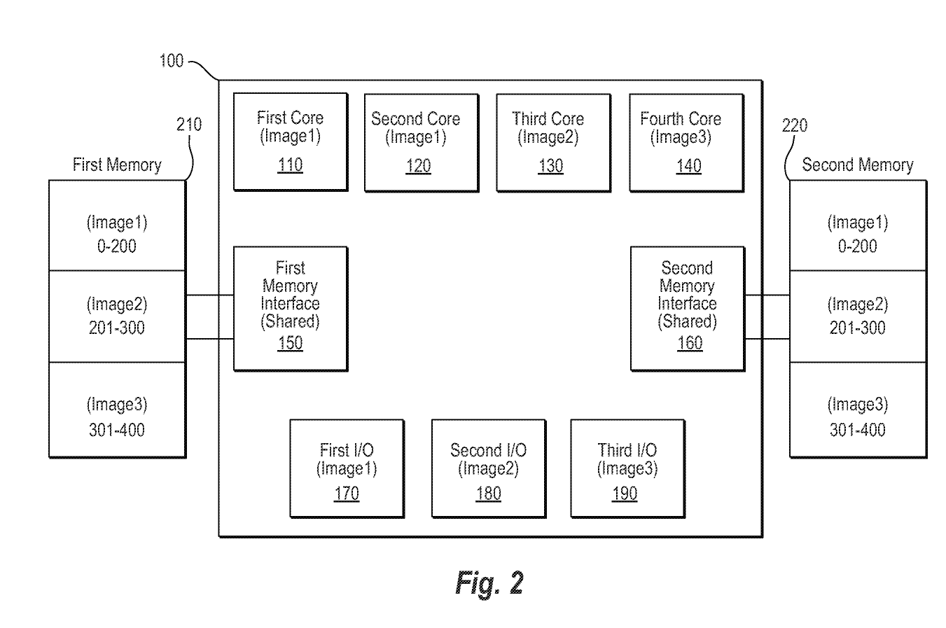

Management logic may be configured to allocate the processor cores (110-140), the memory interface components (150-160), and/or the input/output components (170-190) to the various system images. In some embodiments, one or a group of processor cores may be designated as the “monarch,” and configured to execute the management logic to provide for the allocations. That is, one or a group of processor cores may be responsible for allocating the plurality of processor core components, as well as the memory interface and input/output components, to the various system images. In addition, the monarch may be responsible for, e.g., enabling/disabling the processor core components, allocating shared memory capacity to the system images (discussed in greater detail with respect to FIG. 2), controlling reset functions per core, and/or tracking errors and other relevant events. Enhanced logic within the monarch core(s) and/or within each of the top-level functional blocks may allow isolation between cores, memory address ranges, and the input/output devices. The monarch core(s) may configure the processor 100 into multiple, independent system images (e.g., system image #1, system image #2, and system image #3), with cores or groups of cores enabled and allocated to the system images, along with, e.g., selected address ranges of main memory (not shown) and input/output components (170-190) or a subset of input/output root ports. The monarch core(s) may control reset functions per top level functional unit, such that the on-chip resources may be reconfigured even as other resources continue operation in other system images. The monarch core(s) may further track errors (or other relevant events that impact shared resources) and take appropriate action to notify affected system images. Such tracking logic may be visualized by the monarch core(s), or physically replicated per system image in the management logic.

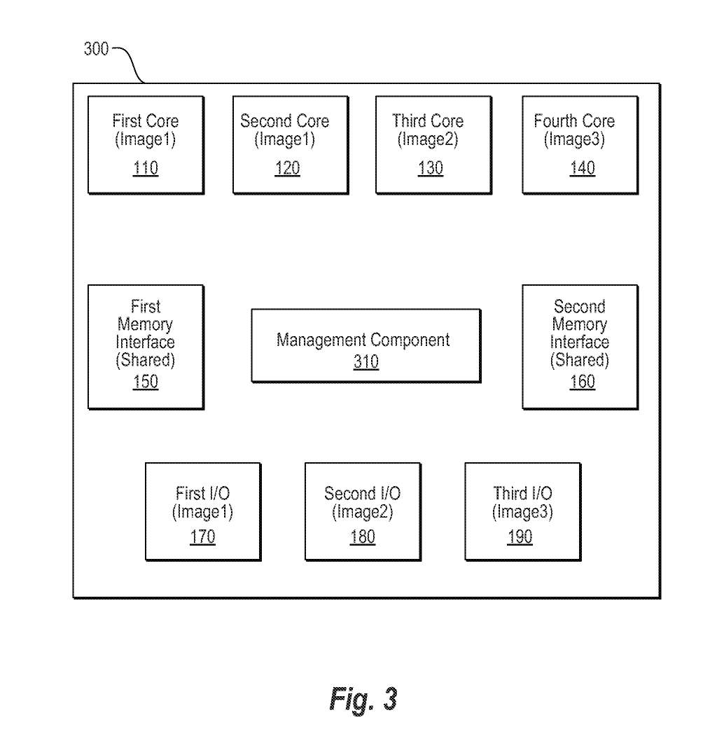

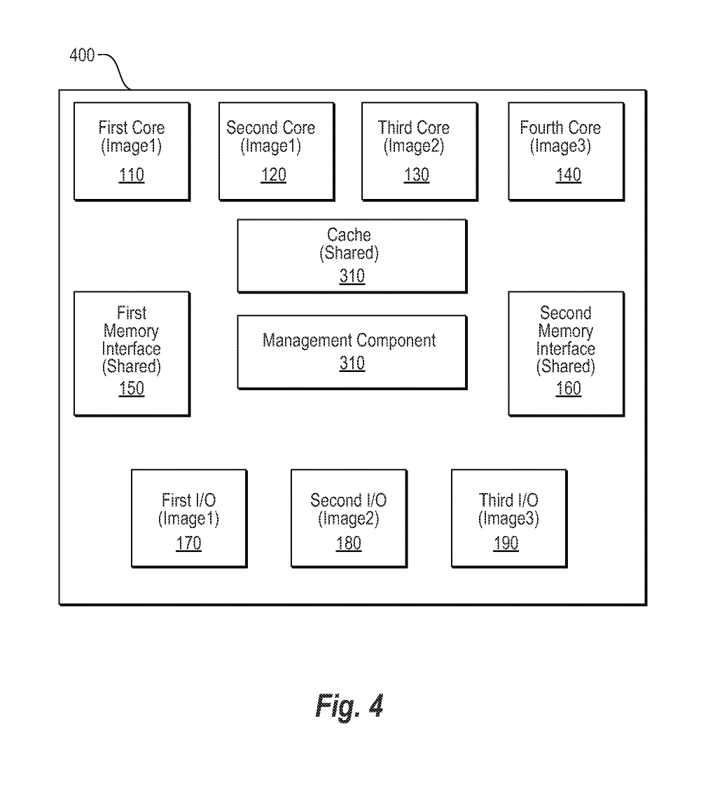

In alternative embodiments discussed below with reference to FIGS. 3 and 4, a separate management component may be included in the processor 100 to conduct the above-mentioned functionality of the monarch processor core(s) via management logic. Therefore, in that implementation, a monarch processor core or group of processor cores may not be utilized.

FIG. 2 depicts a system 200 in accordance with an embodiment. The system 200 comprises a processor 100, a first memory 210, and a second memory 220. It should be readily apparent that the system 200 depicted in FIG. 2 represents a generalized illustration and that other components may be added or existing components may be removed, modified, or rearranged without departing from the scope of the system 200.

The processor 100 is similar to the processor described above with respect to FIG. 1, and comprises a plurality of processor cores (110-140), a plurality of memory interface components (150-160), and a plurality of input/output components (170-190). The first memory 210 and second memory 220 may correspond to any typical storage device that stores data, instructions, or the like. For example, the first memory 210 and second memory 220 may comprise volatile memory or non-volatile memory. Examples of volatile memory include, but are not limited to, static random access memory (SRAM) and dynamic random access memory (DRAM). Examples of non-volatile memory include, but are not limited to, electronically erasable programmable read only memory (EEPROM), read only memory (ROM), and flash memory. The first memory 210 may be communicatively coupled to the first memory interface 150 of the processor 100, and the second memory 220 may be communicatively coupled to the second memory interface 160 of the processor 100. This may be accomplished, for example, via a bus between the memory interface and the memory operating based on a double data rate (DDR) interface specification (e.g., DDR3).

The system images (e.g., system image #1 system image #2, and system image #3) and their respective cores (110-140) may share the memory capacity of the first memory 210 and/or second memory 220. That is, a portion of memory capacity of the first memory 210 and/or second memory 220 may be assigned to each of the plurality of independent and isolated system images. For example, as shown in FIG. 2, the first memory 210 and the second memory 220 may be shared such that system image #1, system image #2, and system image #3 each utilize a portion of the memory capacity. While the first memory 210 and the second memory 228 may be shared, inclusion of an address translation gasket interconnected with the memory interface (not shown) may give the appearance that each system image has a dedicated memory that is independent of the other system images.

In some embodiments, the first memory 210 and the second memory 220 may be partitioned based on address ranges. For example, system image #1 may be assigned address range 0-200, system image #2 may be assigned address range 201-300, and system image #3 may be assigned address range 301-400. While system images are shown as having the same address ranges in the first memory 210 and second memory 220, it should be understood that the system images may also have different assigned address ranges in different memories. Moreover, while the first memory 210 and second memory 220 appear in FIG. 2 to be the same, if should be understood that in various embodiments the first memory 210 and second memory 220 may be different in terms of type, size, speed, and other parameters. For example, the first memory 210 may have a larger storage capacity than the second memory 220. Furthermore, while FIG. 2 shows that each memory is shared by each system image, it should be understood that each memory does not have to be shared by every system image. For example, one memory may be shared by system image #1 and system image number #2, while another memory may be shared by system image #2 and system image #3. Additionally, one memory may be utilized by only a single system image. As discussed above, this memory capacity distribution may be determined by the monarch processor core(s), or, alternatively, by a management component.

FIG. 3 depicts a processor 300 in accordance with another embodiment. Similar to the processor described with respect to FIG. 1, the processor 300 comprises a plurality of processor cores (110-140), a plurality of memory interface components (150-160), and a plurality of input/output components (170-190). In addition, however, the processor comprises a management component 310. The management component 310 may be integrated into the processor 300 and configured to conduct various processes with respect to the system images based on management logic provided therein.

For example, the management component 310 may be responsible for configuring the processor 300 into multiple independent and isolated system images. The management component 310 may allocate the plurality of processor cores (110-140) to different system images, and the allocation may be based, at least in part, on current system demands, anticipated system demands, and/or predefined settings (e.g., setting based on the total cost of operation, power consumption, license cost management (licensing for fewer cores generally costs less) and/or the desire for spare resource). For instance, the management component 310 may allocate multiple cores to a system image that is anticipated to require significant processing power. By contrast, the management component may allocate only a single core to a system image that is anticipated to require minimal processing power. In some embodiments, this allocation may be dynamic, where cores may be reassigned to different system images based on real-time processing power requirements. While in other embodiments, the allocation may be based on predefined settings (e.g., settings provided by an administrator).

The management component 310 may also be responsible for enabling and disabling processing cores. This functionality may promote more efficient use of the processing cores in manner that conserves power and minimized heat dissipation. For example, the management component 310 may disable or place a core in a low power state if the core is not currently being utilized.

The management component 310 may additionally be responsible and configured to apportion the capacity of one or more memories among the plurality of system images. As mentioned, this may be accomplished by assigning each system image an address range within a shared memory. The amount of memory allocated to each system image, however, does not have to be equal.

The management component 310 may further be configured to track errors or other relevant events that may impact one or more cores, memories, memory interfaces, and input/output components, and take appropriate action to notify such components. As part of this process, the management component 310 may control reset functions on a core-by-core or image-by-image basis, where one core/image may be reset without resetting other cores/images on the processor 300. Hence, a detected event that requires a core/image reset does not have a detrimental impact on the other cores/images on the processor.

Furthermore, the management component 310 may be configured to allocate the input/output components (170-190) and associated ports to the respective system images. In some instances, one or more input/output components (170-190) and associated ports may be dedicated to the system images, and in other instances, one or more input/output components (170-190) and associated ports may be shared by one or more system images.

With particular respect to PCIe input/output components, the one or more PCIe root ports may be assigned to each system image. Through these root ports, the system images may access a variety of input/output fabrics, such as Ethernet, InfiniBand, FibreChannel, and network attached storage. Elements that are conventionally shared between root ports (e.g., I/O Advanced Programmable Interrupt Controller (IOAPIC) or address remapping facilities, may be duplicated to maintain independence among the system images. Once each system image is allocated to one or more PCIe root ports, routing the input/output lanes to their final destination may occur in various ways. One approach in accordance with some embodiments is to directly route to requisite input/output resources. Another approach is to utilize a PCIe switch on the processor to allow arbitrary connections of root ports to input/output resources. A still further approach is to utilize an end-point near the destination devices to allow multi-function PCIe devices to be shared by multiple system images. Furthermore, PCIe functions may be implemented directly on the processor to allow direct connectivity to specific input/output fabrics, such as Ethernet. In addition, a small Ethernet switch may be included on the processor so that multiple system images could share an Ethernet connection. With on-chip switching capabilities, the roof pods may not be limited to their native widths, and a wider physical connection can provide access to burst access from a given system image to utilize the full bandwidth provided off the processor.

FIG. 4 depicts a processor 400 in accordance with another embodiment. Similar to the processor 300 described with respect to FIG. 3, the processor 400 comprises a plurality of processor cores (110-140), a plurality of memory interface components (150-160), a plurality of input/output components (170-190), and a management component 310. In addition, however, the processor 400 includes a cache 420. The cache 428 may be a last level cache shared among the plurality of system images. The cache 420 may be utilized by all supported system images by merging a system image identifier into the cache index to allocate an independent portion of the available cache to each system image as programmed through the management component 310. In some embodiments, the allocation of cache is in direct proportion to the number of cores allocated to each system image. In other embodiments, the allocation of cache is based on another metric (e.g., current or anticipated system image requirements) and is not in direct proportion to the number of cores allocated to each system image.

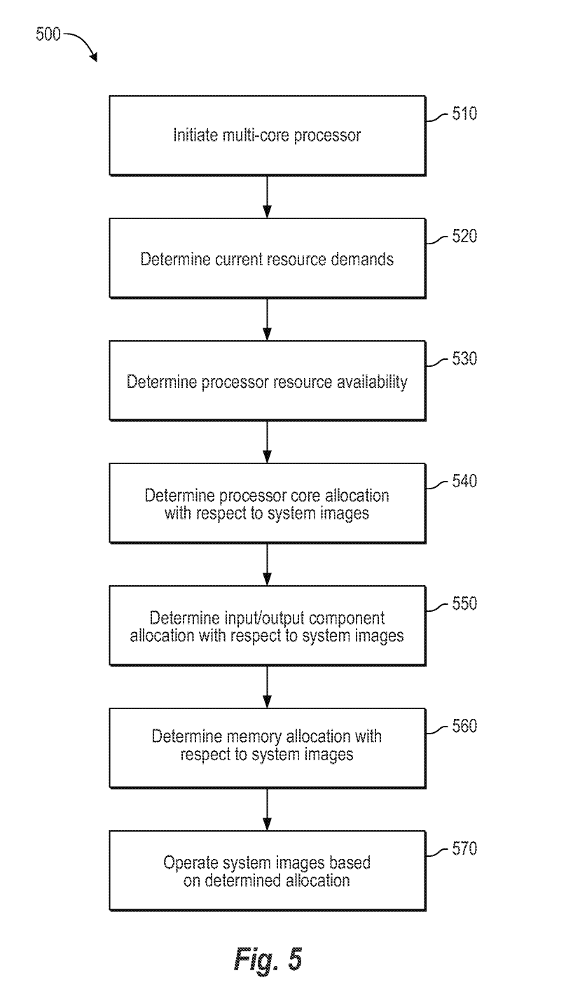

FIG. 5 depicts a process flow diagram 500 in accordance with an embodiment. It should be understood that the processes depicted in FIG. 5 represents generalized illustrations, and that other processes may be added or existing processes may be removed, modified, or rearranged without departing from the scope and spirit of the present disclosure. Furthermore, if should be understood that the processes may represent executable instructions, management logic, or functionally equivalent circuits that may cause a device such a management component or a “monarch” processor core to respond, to perform actions, to change states, and/or to make decisions. In some embodiments, the executable instructions or management logic resides on and is executed by the management component or the monarch processor, while in other embodiments, the executable instructions or management logic resides at least in part on another component that is in communication with the management component or monarch processor. FIG. 5 is not intended to limit the implementation of the described embodiments, but rather to illustrate functional information one skilled in the art could use to design/fabricate circuits, generate software, or use a combination of hardware and software to perform the illustrated processes.

The process may begin at block 510, when a multi-core processor is initiated. This may occur, for example, when the processor receives supply power and prior to the system image or associated operating system booting up.

At block 520, a management component (or “monarch” processor core/cores) may determine or receive information regarding the current resource demand. For example, the management component may determine or receive information that that the system requires three system images to adequately handle system processes. This determination may be made based on, for example, the management component sending requests and receiving responses from other system devices, or based on settings pre-programmed by, e.g., an administrator or the manufacturer.

At block 530, the management component (or “monarch” processor core/cores) may determine or receive information regarding the resource availability on the processor. Such resources may be, for example, processor cores, input/output components, memory interfaces, memory, and cache. For instance, and with reference to FIGS. 1-4, the management component may determine or receive information regarding that there are four processor cores, two memory interfaces, two memories, three input/output components, and a cache available for allocation.

The management component (or “monarch” processor core/cores) may then, at block 540, determine system image allocation per core. This may occur based on processing at the management component or based on instructions received from another component. For example, as shown in FIG. 1, the first processor core 110 and the second processor core 120 may be allocated to system image #1, the third processor core 130 may be allocated to system image #2, and the fourth processor com may be allocated to system image #3. In this example, system image #1 requires more processing resources than system images #2 and #3, and therefore an additional processor core is allocated to this system image.

At block 550, the management component (or “monarch” processor core/cores) may determine or receive information regarding input/output component allocation. As mentioned above, each system image may be allocated a different input/output component or multiple system images may share an input/output component. With particular respect to PCIe input/output components, one or more PCIe root ports may be assigned to each system image, and through these root ports, the system images may access a variety of input/output fabrics such as Ethernet, InfiniBand, FibreChannel, and network attached storage.

At block 560, the management component (or “monarch” processor core/cores) may determine or receive information regarding memory allocation per system image. This may comprise allocation of attached memory (e.g. RAM/ROM) as well as cache. With regard to attached memory, the memory may be shared among all or a portion of the system images. In some embodiments, this allocation occurs based on address regions. For example, and with reference to FIG. 2, system image #1 may be assigned address range 0-200, system image #2 may be assigned address range 201-300, and system image #3 may be assigned address range 301-400. With regard to cache, the cache may be shared by the system images. This may be accomplished, for example, by merging a system image identifier into the cache index to allocate an independent portion of the available cache to each system image as programmed through the management component.

At block 570, after the various allocations to the various system images have been determined, the multi-core processor may conduct operations in accordance with the prescribed allocations.

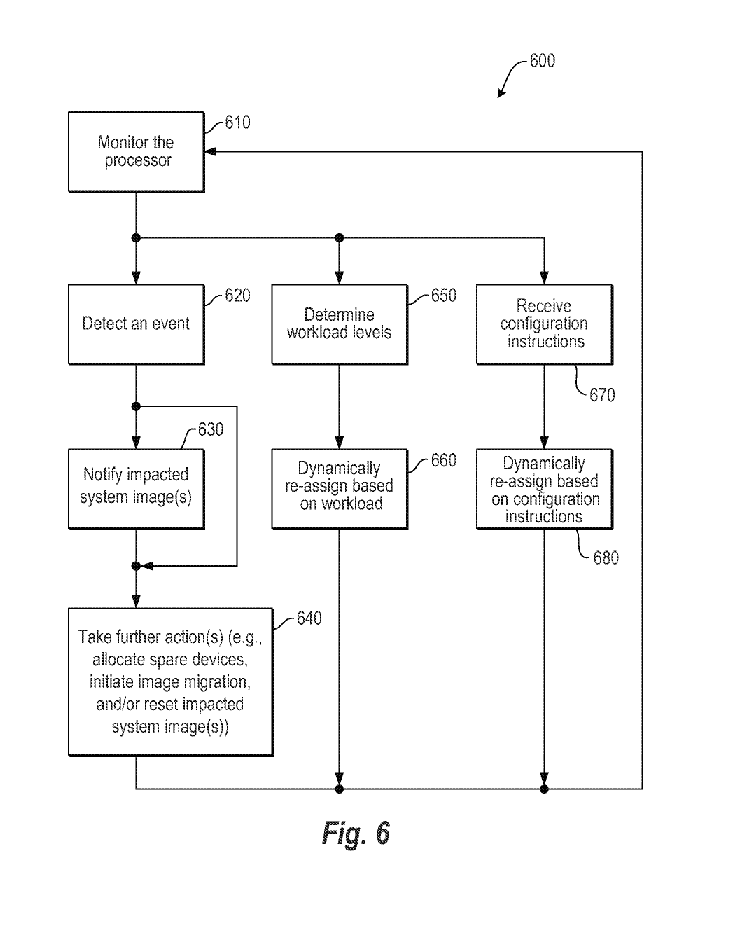

FIG. 6 depicts a process flow diagram 600 in accordance with an embodiment. It should be understood that the processes depicted in FIG. 6 represents generalized illustrations, and that other processes may be added or existing processes may be removed, modified, or rearranged without departing from the scope and spirit of the present disclosure. Furthermore, it should be understood that the processes may represent executable instructions, management logic, or functionally equivalent circuits that may cause a device such a management component or a “monarch” processor core to respond, to perform actions, to change states, and/or to make decisions. In some embodiments, the executable instructions or management logic resides on and is executed by the management component or the monarch processor, while in other embodiments, the executable instructions or management logic resides at least in part on another component that is in communication with the management component or monarch processor. FIG. 8 is not intended to limit the implementation of the described embodiments, but rather to illustrate functional information one skilled in the art could use to design/fabricate circuits, generate software, or use a combination of hardware and software to perform the illustrated processes.

The process may begin at block 610, when the management component (or monarch core/cores) begins monitoring the processor. This may include the management component monitoring the system images, the processor components (e.g., input/output, cache, memory controllers, etc.), and/or the associated components (e.g., attached memory). This may occur, for example, after the processor cores have been allocated to the system images, and after these system images are up and running. As part of the monitoring, the management component may monitor the processor for events, workload levels, and/or configuration instructions.

At block 620, the management component may detect an event. The event may be, for example, an error such as a memory error or a corrupt data error. The management component may evaluate this event and determine a specific course of action. For example, in response to receiving a memory error event, the management component may determine the impacted system image(s) and inform each about the event at block 630. The system image(s) may then take appropriate action upon receipt of the event notification. Alternatively or in addition, the management component may take appropriate actions, such as allocating spare devices, initiating image migration, and/or causing the system image(s) to reset in response to the event, at block 640. The management component may control the reset function on an image-by-image basis, such that one or more system images may be reset without resetting one or more other system images. Thereafter, the process may revert back to block 610, where the management component (or monarch core/cores) continues monitoring the processor.

Additionally, as part of the monitoring process, the management component may determine workload levels at block 650. The management component may then, at block 660, conduct dynamic reallocation based on the current workload level. Such dynamic reallocation may include reallocation of processor cores, memory, and/or input/output components. For example, in response to the management component determining that one system images is heavily loaded due to processor-intensive processes and another system image is only slightly loaded, the management component may reallocate additional processor cores to the heavily loaded system image. In addition, the management component may reallocate memory capacity and/or input output components to the heavily loaded system image if necessary. Thereafter, the process may revert back to block 610, where the management component (or monarch core/cores) continues monitoring the processor.

Furthermore, as part of the monitoring process, the management component may receive configuration instructions at block 670. Such configuration instructions may come from, e.g., another system component (e.g., another processor) or potentially an administrator or administration node. The instructions may include specific system image configuration changes, such as the number of allocated processor cores, the amount of allocated memory, the amount of input/output components, the system image(s) to add/remove, or the like. In response to receiving this configuration information, the management component may proceed to conduct dynamic reallocation based at least in part on the configuration instructions. Thereafter, the process may revert back to block 610, where the management component (or monarch core/cores) continues monitoring the processor.

The present disclosure has been shown and described with reference to the foregoing exemplary embodiments. It is to be understood, however, that other forms, details, and embodiments may be made without departing from the spirit and scope of the disclosure that is defined in the following claims.

What is claimed is:

1. A processor comprising:
a plurality of processing core components;
one or more memory interface components; and
one or more input/output components,
wherein each of the plurality of processing core components is assigned to one of a plurality of independent and isolated system images,
wherein each of the one or more memory interface components is shared by the plurality of independent and isolated system images, and
wherein the one or more input/output components are allocated to the plurality of independent and isolated system images.

2. The processor of claim 1, further comprising a management component to assign each of the plurality of processing core components to one of a plurality of independent and isolated system images.

3. The processor of claim 1, wherein one of the plurality of processing core components is to assign each of the plurality of processing core components to one of a plurality of independent and isolated system images.

4. The processor of claim 1, wherein the processor is fabricated with a single die.

5. The processor of claim 1, wherein two or more of the plurality of processing core components are assigned to one of a plurality of independent and isolated system images.

6. The processor of claim 1, wherein the processor does not utilize a hypervisor.

7. The processor of claim 1, wherein each of the one or more memory interface components is to communicatively couple with a memory component, and wherein a portion of memory capacity of the memory component is assigned to each of the plurality of independent and isolated system images.

8. A system comprising:
a processor comprising
a plurality of processing core components,
one or more memory interface components, and
one or more input/output components,
wherein each of the plurality of processing core components is assigned to one of a plurality of independent and isolated system images,
wherein each of the one or more memory interface components is shared by the plurality of independent and isolated system images, and
wherein the one or more input/output components are allocated to the plurality of independent and isolated system images; and
one or more memory components,
wherein each of the one or more memory components is communicatively coupled to one of the one or more memory interface components, and
wherein a portion of memory capacity of the one or more memory components is assigned to each of the plurality of independent and Isolated system images.

9. The system of claim 8, wherein the portion of memory capacity is a memory address range associated with the memory component.

10. The system of claim 8, wherein the processor further comprises a management device to:
distribute memory component capacity among the plurality of independent and isolated system images;
allocate the one or more input/output components to the plurality of independent and isolated system images; or
defect an error and notify one or more of the plurality of independent and isolated system images about the error.

11. The system of claim 8, wherein the processor further comprises a cache component, wherein the cache component is shared by the plurality of processing core components.

12. The system of claim 8, wherein each of the plurality of independent and isolated system images may be reset without resetting the other of the plurality of independent and isolated system images.

13. A processor comprising:
a plurality of processing core components;
one or more memory Interface components each shared by the plurality of processing core components; and
a management component to assign each of the plurality of processing core components to one of a plurality of system images.

14. The processor of claim 13, wherein the management component is further to enable and disable each of the plurality of processing core components.

15. The processor of claim 13, wherein the management component is further to receive commands from an administrator and re-assign the plurality of processing core components to the plurality of system images based at least in part on the commands received from the administrator.
